(19) United States
(12) Patent Application Publication
(10) Pub. No.: US 2016/0160925 A1
(43) Pub. Date: Jun. 9, 2016

(54) ROLLING BEARING ASSEMBLY WITH CARBON FIBER SEAL

(71) Applicant: Schaeffler Technologies AG & Co. KG, Herzogenaurach (DE)

(72) Inventor: William Moratz, Gardiner, NY (US)

(21) Appl. No.: 14/946,178

(22) Filed: Nov. 19, 2015

Related U.S. Application Data
(60) Provisional application No. 62/087,446, filed on Dec. 4, 2014.

(51) Int. Cl. F16C 33/78

(52) U.S. Cl. CPC F16C 33/7843

(57) ABSTRACT

A rolling bearing assembly including an outer race including a first raceway and a first annular groove arranged on a first side of the first raceway, an inner race arranged radially inward of the outer race and concentric therewith, the inner race including a second raceway arranged radially coincident with the first raceway and a second annular groove arranged in the inner race and a carbon fiber seal arranged between the first groove and the second groove, the carbon fiber comprising a laminate of carbon fibers impregnated with epoxy-based resin. The outer and inner races are operatively arranged to hold a plurality of rolling elements. A rolling bearing assembly including a carbon fiber seal comprising a monolithic structure of carbon fibers impregnated with an epoxy-based resin.

### CROSS-REFERENCE TO RELATED APPLICATIONS

This application claims the benefit under 35 U.S.C. §119(e) of U.S. Provisional Patent Application No. 62/087,446, filed Dec. 4, 2014, which application is incorporated herein by reference in its entirety.

### TECHNICAL FIELD

The present invention relates generally to rolling bearings, and, more particularly, to integrated slip rings, seals or shaft grounding features in rolling bearings which conduct current between the inner and outer rings of the bearings for eliminating or reducing damaging ground shaft currents which can exist within the rolling elements of a bearing.

### BACKGROUND

In electric motors, generators, machines and the like having rolling bearings, electric current exists in the rolling bearings thereby causing damage to the bearings. Due to the current, the raceways and the rollers of the bearing become worn, for example, with pitting or fluting types of wear patterns or corrugation. Fluting caused by electric current can be identified by the dark bottom of the corrugations. Such damage from electric current can cause high noise and shutdown of the machine. Non-rotating bearings are more resistant to electric current damage than bearings in rotation. High speed spindles and other similar machines can be particularly prone to damage from electrical current.

Bearings having ceramic rolling elements are known to electrically insulate the rolling elements and prevent current. Alternatively, bearing seats can be covered with glass impregnated with tape to insulate the bearing. However, a high enough voltage potential can breakdown the insulation and permit current to exist in the bearing. Bearings having a ceramic coated outer ring are also known to insulate the bearing. However, ceramic coatings are expensive and wear with use. Electrical conductive grease is used to conduct electrical currents to the ground in bearings. However, conductive agents in the grease eventually separate and the grease loses its ability to function as a shaft protector and as a lubricant.

U.S. Pat. No. 7,498,703 (Rea, Sr. et al.) discloses a shaft sealing assembly provided on the coupling end of the shaft to prevent the leakage of lubricant from the bearing and/or to protect the bearing from outside contamination. Additionally, the shaft sealing assembly provides a conductive electrical path between the motor shaft and the electrical ground to dissipate electrical charges from the shaft. The shaft sealing assembly includes a rotor adapted for rotation with the motor shaft and a stator adapted for mounting to the housing. An inner radial surface of the rotor is press-fit on the coupling end of the shaft. A ledge surrounding the groove on the stator is sized for a metal-to-metal interference fit between the stator and the bore in the housing. An O-ring provides a seal between the shaft and the rotor and another O-ring provides a seal between the stator and the housing so as to exclude environmental corruption and/or to prevent lubricant leakage. The shaft sealing assembly further includes at least one electrical-path establishing element which forms an electrically conductive path between the shaft and the electrical ground. The electrical-path establishing element can be part of the stator, either permanently fixed to the main body of the stator and/or it can be formed in one piece therewith. The electrical-path establishing element includes a base portion secured to the stator and a tip portion which extends radially inward from the stator to contact the shaft. The tip portion preferably is flexible and includes flexible filaments for sweeping or brushing against the shaft as it rotates during operation of the motor.

United States Patent Application Publication No. 2011/0317953 (Moratz) discloses at least one closure element arranged between an outer ring and an inner ring of a bearing. The closure element aids in ensuring electric current is kept away from the rolling elements by diverting the current from the outer ring to the inner ring of the bearing and onto a shaft of an associated machine. The closure element can take the form of either a seal or a shield. The closure element is arranged in the outer ring and contacts at least one of the notches of the inner ring. Preferably, more than one closure element is used. The bearing closure/shield is secured in at least one annular groove in the outer ring using a snap wire or similar means that is fixed in a groove adjacent to the seal and notches on each side of the raceway of the outer ring. One embodiment of the seal includes an outer layer made of a flexible fiber and an inner layer made of a current conducting material such as copper, steel, or brass. The flexible fiber layer provides stiffening. The inner layer is bonded on or laminated to the outer layer radially inwards of the seal. Other embodiments of the seal disclosed include a flexible fiber including interwoven conductive microfibers and a single layer composed of a flexible fiber with interwoven conductive microfibers. The closure element provides protection from contaminants and the retention of lubricants.

One method of making a conductive seal made of a flexible fiber involves coating a fiber disc with a silver coating; however, this process involves chemicals which are environmentally harmful and impractical for use in a rolling bearing production facility. Another method of making a seal made of flexible fiber includes coating a fiber disc with a carbon coating; however, the carbon coating is not robust. Yet another method of making a conductive seal made of fiber involves bonding a fiber to aluminum and soaking the combination in an oil compatible to bearing grease to prevent fiber material from leaching oil from the grease; however, the process is not practical or effective. The coatings discussed above tend to rub off, are difficult to apply and/or do not adhere effectively.

United States Patent Application Publication No. 2013/0301971 (Cudrnak, et al.)

discloses a closure design of a conductive rubber material for insulating a bearing from current in electric machines. The closure disclosed is impregnated with graphite or a similar material to create a conductive pathway for an electrical current to circumvent rolling elements of a bearing. The rubber material provides protection from debris and retains grease, oil and water.

Graphite is typically particulate in form and formed by crushing mineral graphite or by heating petroleum products at about 2800° C. Graphite fibers can be formed by heating such fibers between approximately 2500° C. to approximately 3000° C. resulting in the distinct crystalline structure of graphite while maintaining a fiber form.

Graphite consists of sheets of carbon atoms which are stacked parallel to one another in regular fashion. The chemical bonds between the sheets are relatively weak. Thus, graphite fibers are soft and brittle.

Thus, there has been a long-felt need for a rolling bearing assembly featuring a seal made of carbon fiber which can conduct current from the housing to the shaft so that it does not conduct current through the rolling element. Furthermore, there is a long-felt need for a rolling bearing assembly featuring a seal made of carbon fiber that is integrated into the rolling bearing. There is also a long-felt need for a simplified, more practical and more effective means of conducting electric current from the housing to the shaft of a rolling bearing without damaging the rolling elements. Finally, there is a long-felt need for a seal made of carbon fiber that contacts the inner race with light pressure, is suitable for higher speeds, and creates negligible wear which causes only a small effect on bearing torque.

### SUMMARY

According to aspects illustrated herein, there is provided a rolling bearing assembly including an outer race including a first raceway and a first annular groove arranged on a first side of the first raceway, an inner race arranged radially inward of the outer race and concentric therewith, the inner race including a second raceway arranged radially coincident with the first raceway and a second annular groove arranged in the inner race and a carbon fiber seal arranged between the first groove and the second groove, the carbon fiber comprising a laminate of carbon fibers impregnated with epoxy-based resin. The outer and inner races are operatively arranged to hold a plurality of rolling elements.

According to aspects illustrated herein, there is provided a rolling bearing assembly including an outer race including a first raceway and a first annular groove arranged on a first side of the first raceway, an inner race arranged radially inward of the outer race and concentric therewith, the inner race including a second raceway arranged radially coincident with the first raceway and a second annular groove arranged in the inner race and a carbon fiber seal arranged between the first groove and the second groove, the carbon fiber comprising a monolithic structure of carbon fibers impregnated with an epoxy-based resin. The outer and inner races are operatively arranged to hold a plurality of rolling elements.

Additionally, the invention includes a rolling bearing assembly including an outer race including a first raceway, a first annular groove arranged on a first side of the first raceway and a second annular groove arranged on a second side of the first raceway, an inner race arranged radially inward of the outer race and concentric therewith, the inner race including a second raceway arranged radially coincident with the first raceway, a third annular groove arranged on a first side of the second raceway and a fourth annular groove arranged on a second side of the second raceway, a first carbon fiber seal arranged between the first annular groove and the third annular groove, a first retaining member operatively arranged to maintain contact between the first seal and the first annular groove, a second carbon fiber seal arranged between the second annular groove and the fourth annular groove and a second retaining member operatively arranged to maintain contact between the second seal and the second annular groove. The rolling bearing assembly is operatively arranged to hold a plurality of rolling elements.

A primary object of the invention is to provide a bearing seal made of carbon fiber. Carbon fiber is desirable due to its high strength-to-weight ratio and its inherent thermal and electric conductivity. Carbon fibers have high tensile strength, low density, low weight, low thermal expansion and excellent fatigue resistance. Additionally, carbon fibers are formed from organic polymers, such as polyacrylonitrile and are treated through oxidation in air at between approximately 200° C. and 300° C. to form non-meltable precursor fibers. Such precursor fibers are then heated in a nitrogen environment at about 1000° C. to about 2500° C. to form carbon fibers. Carbon fibers typically include approximately 92.0 wt % carbon. It should be appreciated that the carbon fibers used for the invention include some graphite content ideally.

In a preferred embodiment, the carbon fibers include approximately 10-20% graphite. Carbon fiber is preferable in this area over graphite fiber because it is stiffer. Additionally, carbon fiber is better at impinging high pressure liquids as compared with a seal made of rubber.

Another object of the invention is to provide a rolling bearing assembly featuring a seal made of carbon fiber which can conduct current from the housing to the shaft without damaging the rolling elements.

Yet another object of the invention is to provide a rolling bearing assembly featuring a seal made of carbon fiber that is integrated into the rolling bearing.

Still another object of the invention is to provide a simplified, more practical and more effective means of conducting current from the housing to the shaft of a rolling bearing without damaging the rolling elements.

A further object of the invention is to provide a seal made of carbon fiber that contacts the inner race with light pressure, is suitable for higher speeds, and creates negligible wear which causes only a small effect on bearing torque.

These and other objects, features and advantages of the present invention will become readily apparent upon a review of the following detailed description of the invention, in view of the drawings and appended claims.

### BRIEF DESCRIPTION OF THE DRAWINGS

The nature and mode of operation of the present invention will now be more fully described in the following detailed description of the invention taken with the accompanying figures, in which:

FIG. 1 is a perspective view of a cylindrical coordinate system demonstrating spatial terminology used in the present application; and,

FIG. 2 is a cross-sectional view of a bearing assembly incorporating a seal of the invention.

### DETAILED DESCRIPTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention.

Unless defined otherwise, all technical and scientific terms used herein have the same meaning as commonly understood to one of ordinary skill in the art to which this invention pertains. The term “long” used herein to modify fibers means the fibers are woven into sheets in a specific pattern and then cut into their desired shape. Fibers which are referred to as “short” are strands of fiber which are chopped up and mixed with an epoxy-based resin before being stamped into the desired shape. It should be appreciated that the fibers referred to herein can be any length based on preference and/or application. It should be understood that any methods, devices or materials similar or equivalent to those described herein can be used in the practice or testing of the invention.

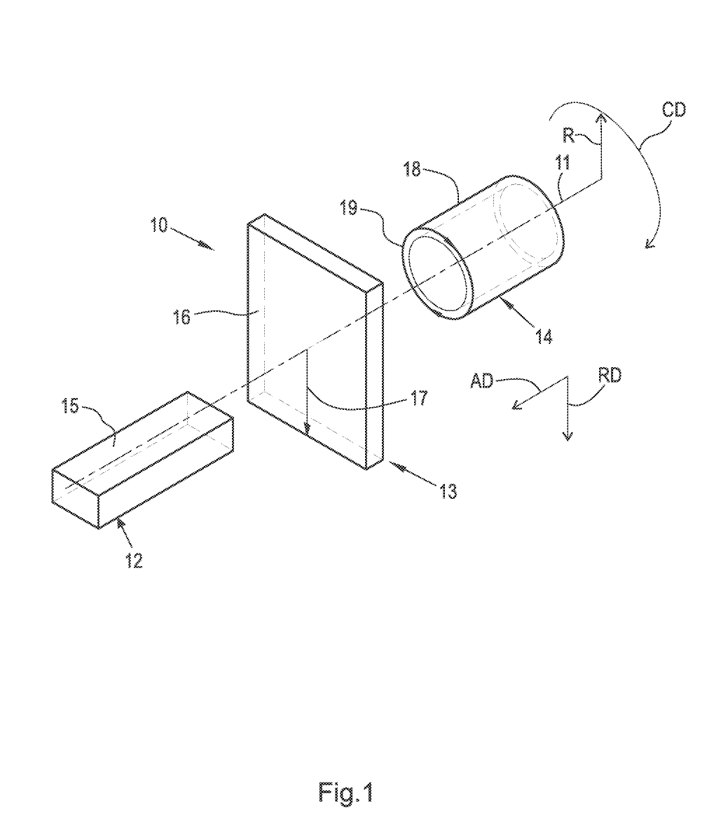

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19.

Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

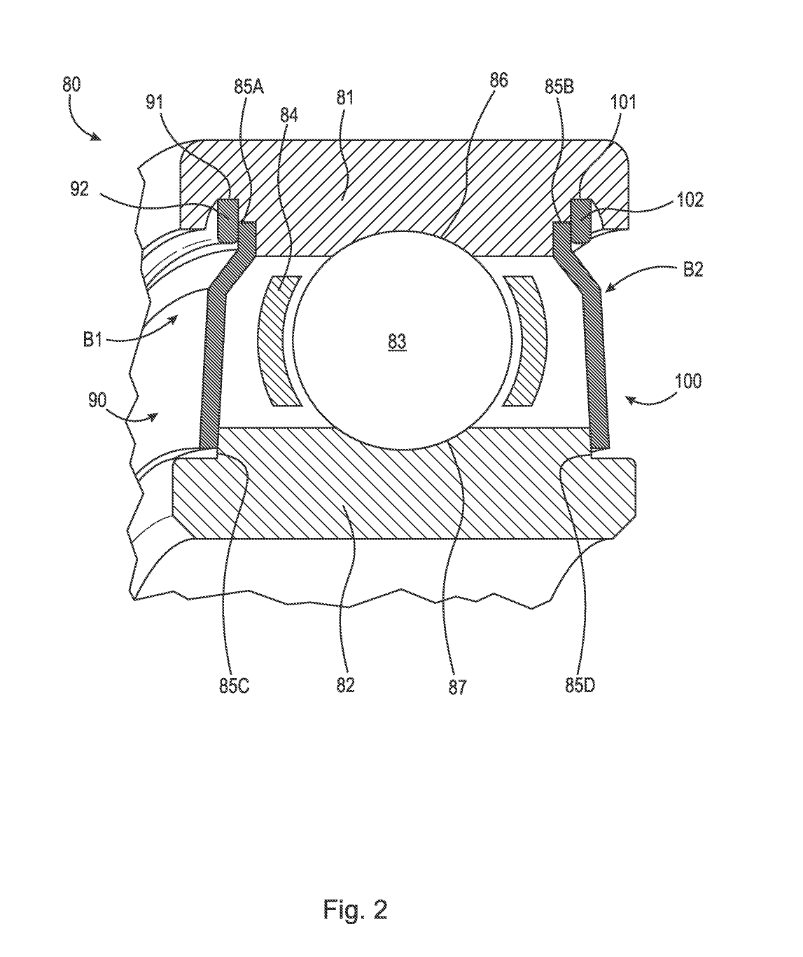

Bearing assembly 80 is shown in FIG. 2. Bearing assembly 80 broadly comprises outer ring 81 and inner ring 82. Plurality of rolling elements 83 are arranged between outer ring 81 and inner ring 82. Cage 84 is used to secure plurality of rolling elements 83 within outer ring 81 and inner ring 82. Outer ring 81 includes annular grooves 85A and 85B. Annular groove 85A is arranged on a first side of raceway 86 within outer ring 81. Similarly, annular groove 85B is arranged on a second side of raceway 86 within outer ring 81. In a preferred embodiment, annular grooves 85A and 85B are equidistant from raceway 86. Inner ring 82 includes annular grooves 85C and 85D Annular groove 85C is arranged on a first side of raceway 87 within inner ring 82. Similarly, annular groove 85D is arranged on a second side of raceway 87 within inner ring 82. Rolling elements 83 are rotatable within raceways 86 and 87. As shown in FIG. 2, in a preferred embodiment, annular grooves 85A and 85B are arranged closer to raceway 86 than annular grooves 85C and 85D are arranged with respect to raceway 87. Outer and inner rings 81 and 82 are rotatable with respect to each other. However, outer ring 81 can be mounted within a housing and, in that case, outer ring 81 becomes non-rotatable and inner ring 82 is rotatable with respect to outer ring 81 and the housing. It should be appreciated however, that inner ring 82 can be mounted within a housing; in that case, inner ring 82 becomes non-rotatable and outer ring 81 is rotatable with respect to inner ring 82. Seals 90 and 100 can be used with either arrangement.

Seals 90 and 100 are arranged to contact annular grooves 85A and 85C and annular grooves 85B and 85D, respectively. It should be appreciated that seals 90 and 100 are arranged between outer ring 81 and inner ring 82 to conduct current between outer ring 81 and inner ring 82 such that plurality of rolling elements 83 are insulated from the current. Preferably, seals 90 and 100 are secured to outer ring 81 although it should be appreciated that, in alternate embodiments, seals 90 and 100 could be secured to inner ring 82. In FIG. 2, seals 90 and 100 are secured to outer ring 81 by retaining members 92 and 102, respectively. Retaining member 92 is held within groove 91 which is adjacent to seal 90 proximate annular groove 85A. Retaining member 102 is held within annular groove 101 which is adjacent to seal 100 proximate annular groove 85B. Retaining members 92 and 102 are operatively arranged to maintain contact between seals 90 and 100 and outer ring 81. It should be appreciated that retaining members 92 and 102 can be snap wires in a preferred embodiment. However, retaining members 92 and 102 can be substituted with any suitable alternative structure for achieving the same contact between seals 90 and 100 and outer ring 81. Seals 90 and 100 include axial bends B1 and B2, respectively. Since annular grooves 85C and 85D are arranged farther outward from raceway 87 as compared with annular grooves 85A and 85B with respect to raceway 86, axial bends B1 and B2 enable seals 90 and 100 to contact outer ring 81 and inner ring 82.

It should be appreciated that seals 90 and 100 are made of carbon fiber preferably. As described above, seals 90 and 100 described herein conduct current between outer ring 81 and inner ring 82 such that the current is not conducted through rolling elements 83. However, seals 90 and 100 provide only a minor amount of debris protection. Seals 90 and 100 are not designed or arranged to provide ultimate protection from contaminants, such as, debris as provided in typical seals. Additionally, seals 90 and 100 are not designed or arranged to ultimately retain lubricants, such as, grease, oil, or water as provided in typical seals.

It should be appreciated that seals 90 and 100 could be formed by stamping a piece of commercially available sheet carbon fiber using different dies. For example, seals 90 and 100 could be made of CL4-0.030″ Thick Unidirectional Carbon Fiber Laminates available from ACP Composites located at 78 Lindbergh Avenue, Livermore, Calif. 94551. Such laminates are manufactured with 250° F. cure carbon fiber pre-pregnated, laid up to the required thickness and fiber orientation and cured with heat (250° F.) and pressure. In a preferred embodiment, seals 90 and 100 are surface treated to improve the matrix bonding and chemical sizing to protect the fibers during handling. In an example embodiment, a gloss surface treatment could be used for visual appeal. In another example embodiment, the commercially available sheet carbon fiber has bondable roughened surfaces on both sides and thickness tolerances of approximately +/−0.005″. In a preferred embodiment, seals 90 and 100 are formed of medium modulus (34 MSI) carbon fiber and can be single ply or multiple ply. In a preferred embodiment, the carbon fiber sheet is multiple ply and bidirectional. In an example embodiment, carbon fibers are cut to form a seal, the fibers are cured with the epoxy-based resin and then heated.

As described above, carbon fiber has the highest specific stiffness of any commercially available fiber and a very high strength in both tension and compression. Due to the stiffness of carbon fiber, there is no need to add a flexible layer or other component to provide stiffening to seals 90 and 100. Accordingly, seals 90 and 100 made of carbon fiber are stiff. At the same time, seals 90 and 100 made of carbon fiber are flexible. It should be appreciated that seals 90 and 100 are deformable when a force is applied, for example, when positioning seals 90 and 100 within annular grooves 85C and 85D of inner ring 82. However, seals 90 and 100 do not deform permanently unless the force applied exceeds the modulus of resilience of the carbon fiber. In other words, if a typical force is applied to seal 90 and/or seal 100, after the typical force is removed from seal 90 and/or seal 100, seal 90 and/or seal 100 returns to its original intended shape. Thus, seals 90 and 100 are stiff and resilient. It should be appreciated that any other material that is similarly stiff, resilient, and conductive could be used as an alternative to carbon fiber to form seals 90 and 100.

Seals 90 and 100 can be punched or cut out from commercially available sheet carbon fiber. In one example embodiment, seals 90 and 100 are discs cut out of a sheet of commercially available pre-pregnated carbon fiber. In another example embodiment, seals 90 and 100 are cut from a bidirectional carbon fiber sheet so that the orientation of the fibers within the races does not play a significant role. In an example embodiment, carbon fibers are oriented parallel to each other. Thus, seals 90 and 100 are less costly than the alternatives seals described herein. Additionally, seals 90 and 100 made of carbon fiber have notable wear resistance and can have a unique and attractive appearance.

In a preferred embodiment, the carbon fibers used to form seals 90 and 100 are as long as practicable. It should be appreciated, however, that long graphite fibers could be used as an alternative to long carbon fibers. Short fibers tend to be problematic because they can interfere with the bearing. In a glass fiber reinforced polyamide 6/6 cage, for example, fibers must be oriented so that they do not scrub against moving rolling bodies. If fibers penetrate the bearing, they can act as contaminants. The orientation of the fibers in the glass fiber reinforced polyamide 6/6 cage generates wear. Seals 90 and 100 of the invention, preferably using long carbon fibers, prevent the fibers from scrubbing off against a contacting surface and contaminating the bearing.

It will be appreciated that various aspects of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

80 Bearing assembly
81 Outer ring
82 Inner ring
83 Rolling elements
84 Cage
85A Annular groove
85B Annular groove
85C Annular groove
85D Annular groove
86 Raceway
87 Raceway
90 Seal
91 Annular groove
92 Retaining member
100 Seal
101 Annular groove
102 Retaining member
B1 Bend
B2 Bend

What is claimed is:

1. A rolling bearing assembly, comprising:
an outer race including:
a first raceway; and,
a first annular groove arranged on a first side of said first raceway;
an inner race arranged radially inward of said outer race and concentric therewith, said inner race including:
a second raceway arranged radially coincident with said first raceway; and,
a second annular groove arranged in said inner race; and,
a carbon fiber seal arranged between said first groove and said second groove, said carbon fiber comprising a laminate of carbon fibers impregnated with epoxy-based resin;
wherein said outer and inner races are operatively arranged to hold a plurality of rolling elements.

2. The rolling bearing assembly recited in claim 1, further comprising a retaining member operatively arranged to urge said seal toward said first raceway.

3. The rolling bearing assembly recited in claim 1, wherein said carbon fibers are cut to form said at least one seal, cured with said epoxy-based resin, and then heated.

4. The rolling bearing assembly recited in claim 1, wherein said carbon fibers are stamped.

5. The rolling bearing assembly recited in claim 1, wherein said carbon fibers are oriented parallel to each other.

6. The rolling bearing assembly recited in claim 1, wherein said carbon fibers are long meaning that they are woven into a sheet.

7. A rolling bearing assembly, comprising:
an outer race including:
a first raceway; and,
a first annular groove arranged on a first side of said first raceway;
an inner race arranged radially inward of said outer race and concentric therewith, said inner race including:
a second raceway arranged radially coincident with said first raceway; and,
a second annular groove arranged in said inner race; and,
a carbon fiber seal arranged between said first groove and said second groove, said carbon fiber comprising a monolithic structure of carbon fibers impregnated with an epoxy-based resin;
wherein said outer and inner races are operatively arranged to hold a plurality of rolling elements.

8. The rolling bearing assembly recited in claim 7, further comprising a retaining member operatively arranged to urge said seal toward said first raceway.

9. The rolling bearing assembly recited in claim 7, wherein said carbon fibers are cut to form said at least one seal, cured with said epoxy-based resin, and then heated.

10. The rolling bearing assembly recited in claim 7, wherein said carbon fibers are stamped.

11. The rolling bearing assembly recited in claim 7, wherein said carbon fibers are oriented parallel to each other.

12. The rolling bearing assembly recited in claim 7, wherein said carbon fibers are long meaning that they are woven into a sheet.

13. A rolling bearing assembly, comprising:
an outer race including:
a first raceway;
a first annular groove arranged on a first side of said first raceway; and
a second annular groove arranged on a second side of said first raceway;
an inner race arranged radially inward of said outer race and concentric therewith, said inner race including:
a second raceway arranged radially coincident with said first raceway;
a third annular groove arranged on a first side of said second raceway; and,
a fourth annular groove arranged on a second side of said second raceway;
a first carbon fiber seal arranged between said first annular groove and said third annular groove;
a first retaining member operatively arranged to maintain contact between said first seal and said first annular groove;
a second carbon fiber seal arranged between said second annular groove and said fourth annular groove; and,
a second retaining member operatively arranged to maintain contact between said second seal and said second annular groove;
wherein said rolling bearing assembly is operatively arranged to hold a plurality of rolling elements.
